(19) United States
(12) Patent Application Publication
(10) Pub. No.: US 2026/0309436 A1
(43) Pub. Date: Oct. 8, 2026

(54) METHOD FOR PREVENTING CONTAMINATION IN HEAT EXCHANGERS

(71) Applicant: KITURAMI CO.,LTD., Cheongdo-gun (KR)

(72) Inventors: Young-Deok PARK, Seoul (KR); Young Hwan CHOI, Seoul (KR); Kihwan NAM, Seoul (KR)

(73) Assignee: KITURAMI CO.,LTD., Cheongdo-gun (KR)

(21) Appl. No.: 19/641,810

(22) Filed: Apr. 8, 2026

(30) Foreign Application Priority Data
Apr. 8, 2025 (KR) 10-2025-0045396

(51) Int. Cl. F28G 11/00; F28G 15/00

(52) U.S. Cl. CPC F28G 11/00; F28G 15/003

(57) ABSTRACT

A method for preventing contamination in heat exchangers according to the present invention may include a blower purge step of removing contaminants inside a heat exchanger through blowing after combustion is stopped, and a cleaning step of cleaning an inside of the heat exchanger after the blower purge step.

### CROSS-REFERENCE TO RELATED PATENT APPLICATION

This application claims the benefit of Korean Patent Application No. 10-2025-0045396, filed on Apr. 8, 2025, in the Korean Intellectual Property Office, the disclosure of which is incorporated herein in its entirety by reference.

### TECHNICAL FIELD

The present invention relates to a method for preventing contamination of a heat exchanger, and more particularly, to a method for preventing contamination of the heat exchanger by removing various contaminants including a corrosion-causing substance within the heat exchanger through operation control of a combustion device.

### BACKGROUND ART

A heat exchanger is a device that continuously transfers heat from one fluid to another fluid, and is capable of heating, cooling, evaporation, and condensation. The heat exchanger may be utilized for various purposes including a domestic boiler as well as an industrial boiler using heat.

Among heat exchangers, a condensing heat exchanger is a device that primarily recovers latent heat generated in a process of cooling steam or gas to condense the steam or gas into a liquid, thereby heating another fluid. Specifically, the steam or gas is cooled to change into a liquid state, and heat released in this process is transferred to another fluid. The condensing heat exchanger is widely used particularly in a system where energy efficiency is important.

A representative example of the condensing heat exchanger is a condensing heat exchanger for a boiler, in which a heat transfer tube through which a fluid circulates is disposed on an exhaust path of combustion gas generated during combustion of fuel gas in a burner, thereby transferring latent heat of the combustion gas to the metal heat transfer tube to heat the fluid within the heat transfer tube. In the condensing heat exchanger, condensate is inevitably generated.

In the condensing heat exchanger, since moisture, oxygen, and chemical substances contact a metal surface such as the metal heat transfer tube during a heat exchange process to cause corrosion, efforts to prevent the corrosion are important. The chemical substances causing the corrosion may include a nitric acid component or a sulfur gas component. In the case of the sulfur gas component, the sulfur gas component may be included in the fuel gas as an odorant.

Conventionally, various methods have been used to prevent metal corrosion of the heat exchanger. As conventional methods for preventing the metal corrosion, various methods have been used, including a method of manufacturing a metal component with a corrosion-resistant material strong against corrosion, a method of forming an oxide film on a surface of the metal component, a method of coating an inside of the heat exchanger with an epoxy resin and the like, a method of using a corrosion inhibitor, and a method of designing an efficient condensate discharge structure so that the condensate does not remain on a surface of the heat exchanger for a long time.

However, in the case of the conventional metal corrosion prevention methods as described above, there are limitations to widespread application due to problems of increased costs caused by additional processes, such as requiring further additional processes in a manufacturing process and requiring a separate design for the condensate discharge structure.

Meanwhile, various contaminants including the corrosion-causing substance may exist in the heat exchanger, and when the contaminants accumulate in a heat exchanger passage, heat exchange efficiency may be degraded. In addition, when the contaminants are continuously accumulated, a problem in which the heat exchanger passage is partially or entirely blocked may occur, and in this case, normal operation of the heat exchanger may become difficult.

### SUMMARY OF THE INVENTION

### Technical Problem

The present invention is directed to solving the problems of the prior art as described above, and an object of the present invention is to provide a method for preventing contamination in heat exchangers, which can prevent contamination and corrosion of a heat exchanger by effectively removing the corrosion-causing substance and other contaminants accumulated in the heat exchanger while minimizing additional processes and cost increases, and which can be applied to various heat exchangers.

However, technical problems to be solved by the present invention are not limited to the above-described problems, and other unmentioned problems will be clearly understood by those skilled in the art from the description of the invention provided below.

### Solution to the Problem

A method for preventing contamination in heat exchangers according to a preferred embodiment of the present invention for achieving the above object may include a blower purge step of removing contaminants inside the heat exchanger through blowing after combustion is stopped, and a cleaning step of cleaning an inside of the heat exchanger after the blower purge step.

The blower purge step may include removing the condensate and the contaminants including the corrosion-causing substance from the inside of the heat exchanger.

The blower purge step may include preventing blockage of a combustion gas passage inside the heat exchanger through the blowing.

The blower purge step may proceed until a discharge temperature of heating water or hot water discharged from the heat exchanger drops to or below a condensing temperature.

In the cleaning step, condensate may be generated inside the heat exchanger during a process of resuming the combustion, and the corrosion-causing substance inside the heat exchanger may be cleaned with the generated condensate.

In the cleaning step, the discharge temperature of the heating water or hot water discharged from the heat exchanger may be controlled to be maintained at or below the condensing temperature.

The method for preventing contamination in heat exchangers according to the present invention may further include an initial operation step of starting operation of the combustion device according to an operation signal to continuously perform combustion for a set time prior to the combustion stop and the blower purge step.

The initial operation step may include a first load increasing section for increasing a load according to the operation signal, a first maximum load section for maintaining a maximum load after the first load increasing section, a first proportional control section for gradually decreasing the load after the first maximum load section, and a first low-load section for maintaining the load in a low-load state after the first proportional control section.

The cleaning step may include a second load increasing section for increasing an amount of heat transferred to the heat exchanger, and a second low-load section for keeping the load constant after the second load increasing section.

The method for preventing contamination in heat exchangers according to the present invention may further include a normal operation step of passing through a second maximum load section in which the maximum load is maintained after passing through a third load increasing section in which the load is increased after the cleaning step.

The normal operation step may further include a second proportional control section for gradually decreasing the load after the second maximum load section, and a third low-load section for maintaining the load in the low-load state after the proportional control section.

In the second low-load section, more condensate may be generated compared to the first low-load section and the third low-load section.

In the blower purge step, a rotation speed of a blower may be controlled to be greater than a rotation speed in the first low-load section and the third low-load section and less than or equal to a set maximum rotation speed.

After the initial operation step, the combustion stop, the blower purge step, the cleaning step, and the normal operation step may be repeated.

The method for preventing contamination in heat exchangers according to a preferred embodiment of the present invention for achieving the above object may include: a normal operation step of the combustion device; a blower purge step of removing contaminants inside the heat exchanger through blowing after stopping combustion of the combustion device; and a cleaning step of cleaning the inside of the heat exchanger after the blower purge step.

The cleaning step may include generating condensate inside the heat exchanger and cleaning the contaminants including the corrosion-causing substance inside the heat exchanger with the generated condensate.

The blower purge step may include removing the condensate and the contaminants including the corrosion-causing substance inside the heat exchanger through the blowing.

The blower purge step may include preventing blockage of the combustion gas passage inside the heat exchanger through the blowing.

The blower purge step may proceed until the discharge temperature of the heating water or hot water discharged from the heat exchanger drops to or below the condensing temperature.

The method for preventing contamination in heat exchangers according to the present invention includes: a blower purge step of removing contaminants and condensate inside the heat exchanger by performing blowing after combustion is stopped; a condensation generating step of generating condensate inside the heat exchanger by controlling a discharge temperature of heating water or hot water discharged from the heat exchanger to be maintained at or below a condensing temperature while resuming combustion; and a cleaning step of cleaning the contaminants including the corrosion-causing substance inside the heat exchanger by the generated condensate, wherein the combustion stop, the blower purge step, the condensation generating step, and the cleaning step may be repeatedly performed.

### Advantageous Effects of the Invention

According to the method for preventing contamination in heat exchangers of the present invention, various contaminants and condensate including the corrosion-causing substance remaining inside the heat exchanger can be effectively removed by supplying air into the heat exchanger using a blower in a state in which combustion is stopped through the combustion stop and blower purge step after normal combustion for a predetermined time. Accordingly, accumulation of the contaminants inside the heat exchanger can be prevented, corrosion can be prevented, and a clogging phenomenon in a heat exchanger passage can also be effectively prevented. In addition, even when the clogging occurs due to the contaminants in the heat exchanger passage, the clogging phenomenon can be resolved by removing the contaminants through the blowing.

Furthermore, according to the method for preventing contamination in heat exchangers of the present invention, by passing through a cleaning step of resuming combustion after the combustion stop and blower purge step to generate a large amount of condensate while controlling a discharge-side temperature of heating water or hot water to a temperature equal to or lower than a condensing temperature and removing the condensate by wind of the blower, various contaminants including the corrosion-causing substance remaining inside the heat exchanger can be effectively removed by dissolving the contaminants in the condensate.

As described above, according to the method for preventing contamination in heat exchangers of the present invention, various contaminants including the corrosion-causing substance and the condensate can be effectively removed only by controlling the operation of the combustion device, and thus the method can be applied without an additional separate process, structural change, or component change, thereby preventing an increase in manufacturing costs.

However, the effects according to the present invention are not limited to the above-described effects, and other technical effects not mentioned will be clearly understood by those skilled in the art from the description of the invention described below.

### BRIEF DESCRIPTION OF DRAWINGS

FIG. 1 is a cross-sectional view showing an example of an instantaneous heat exchanger to which a method for preventing contamination in heat exchangers according to an embodiment of the present invention is applied.

FIG. 2 is a cross-sectional view showing an example of a storage-type heat exchanger to which the method for preventing contamination in heat exchangers according to an embodiment of the present invention is applied.

FIG. 3 is a configuration diagram showing a relationship among components used in the method for preventing contamination in heat exchangers according to an embodiment of the present invention.

FIG. 4 is a flowchart according to the method for preventing contamination in heat exchangers according to an embodiment of the present invention.

FIG. 5 is a flow diagram showing an order in which processes are performed according to the method for preventing contamination in heat exchangers according to an embodiment of the present invention.

FIG. 6 is a graph showing changes in a boiler heat amount, a blower rotation speed, a heating water discharge temperature, and a heating water return temperature in a process in which processes are performed according to the method for preventing contamination in heat exchangers according to an embodiment of the present invention.

### DETAILED DESCRIPTION OF THE INVENTION

Hereinafter, specific details for carrying out the present invention will be described in detail with reference to the accompanying drawings. However, in the following description, specific descriptions of well-known functions or configurations will be omitted if there is a concern that they may unnecessarily obscure the gist of the present invention. Singular expressions in this specification may include plural expressions unless the context clearly indicates otherwise. In addition, plural expressions may include singular expressions unless the context clearly indicates otherwise. Throughout this specification, when a portion is stated to “comprise” a component, this means that it may further include other components and does not exclude other components, unless otherwise stated. In this specification, terms such as “comprise” or “comprising” may indicate the presence of features, steps, operations, elements, and/or components, but do not exclude the addition of one or more other functions, steps, operations, elements, components, and/or combinations thereof. In this specification, when a specific component is referred to as being “coupled”, “combined”, “connected”, or “reacting” with any other component, the specific component may be directly coupled, combined, and/or connected to, or react with the other component, but is not limited thereto. For example, there may be one or more intermediate components between a particular component and another component. Additionally, in the present invention, “and/or” may include each of one or more of the listed items or a combination of at least a portion of one or more of the listed items. In this specification, terms such as “first” and “second” are used to distinguish a specific component from other components, and the above-described components are not limited by these terms. For example, the “first” component may be an element of the same or similar form as the “second” component. Hereinafter, the corrosion-causing substance will be exemplarily described as the contaminant to be removed.

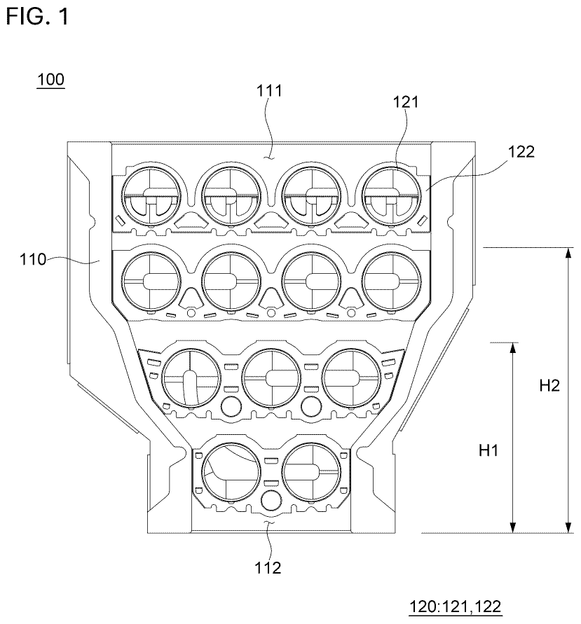

FIG. 1 is a cross-sectional view showing an example of an instantaneous heat exchanger to which a method for preventing contamination in heat exchangers according to an embodiment of the present invention is applied.

In the instantaneous heat exchanger 100 to which the method for preventing contamination in heat exchangers according to the embodiment of the present invention is applied, a heat exchanger housing 110 and a heat exchange portion 120 composed of a heat transfer tube 121 and plate-shaped heat transfer fins 122 surrounding the heat transfer tube 121 may be disposed in at least one stage.

The heat exchanger housing 110 has an inner space forming a combustion gas transfer path through which combustion gas moves, and is provided with an intake portion 111 connected to a combustion chamber (not shown) at an upper end thereof and an exhaust portion 112 connected to an exhaust passage (not shown) at a lower end thereof. The combustion gas moves from top to bottom through the combustion gas transfer path.

In the case of the instantaneous heat exchanger 100 configured as described above, the combustion gas generated in the combustion chamber passes between the heat transfer tubes 121 and between the heat transfer fins 122 to heat the heating water through heat exchange with the heating water flowing through the heat transfer tube 121.

In the instantaneous heat exchanger 100, the condensate may be generated on a surface of the heat transfer tube 121 according to a temperature of the heating water flowing inside the heat transfer tube 121. Specifically, the condensate may be generated when the temperature of the heating water flowing through the heat transfer tube 121 is 55° C. or less. Therefore, when the temperature of the heating water is around 55° C., the generation of the condensate and drying may be repeatedly performed. The condensate may be generated on a surface of a metal part such as the heat transfer fin 122 in addition to the heat transfer tube 121.

According to the instantaneous heat exchanger 100 having the above structure, when an amount of heat of the combustion gas is low, the condensate may be generated up to a relatively higher section than when the amount of heat of the combustion gas is high. Specifically, FIG. 1 exemplarily shows that a section in which the condensate is generated is H1 when the amount of heat of the combustion gas is relatively high, and a section in which the condensate is generated is H2 when the amount of heat of the combustion gas is relatively low. This shows that when the amount of heat of the combustion gas is low, the condensate is generated up to the higher section. Accordingly, in a section other than a section overlapping with the H1 section among the H2 section, the generation of the condensate and the drying are repeatedly performed, and a large amount of the corrosion-causing substance may be generated in this section.

A flow of heating water in the instantaneous heat exchanger 100 may be achieved through the plurality of heat transfer tubes 121 disposed in the heat exchanger housing 110 and a plurality of water tanks (not shown) disposed on front and rear plates of the heat exchanger housing 110 to connect ends of the heat transfer tubes. Heating return water may be introduced through the heat transfer tube located on a lower side of the heat exchanger housing 110, that is, a side of the exhaust portion 112, and heated heating water may be discharged through the heat transfer tube located on an upper side of the heat exchanger housing 110, that is, a side of the intake portion 111.

The instantaneous heat exchanger 100 of FIG. 1 may be applied to generating hot water as well as heating the heating water. In this case, direct water may be introduced through the heat transfer tube located on the lower side of the heat exchanger housing 110, and generated hot water may be discharged through the heat transfer tube located on the upper side of the heat exchanger housing 110.

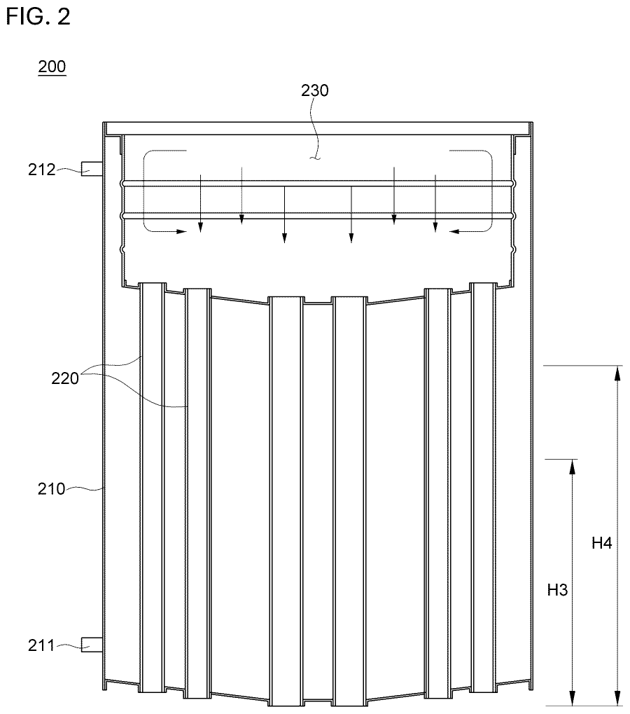

FIG. 2 is a cross-sectional view showing an example of the storage-type heat exchanger to which the method for preventing contamination in heat exchangers according to the embodiment of the present invention is applied.

In the storage-type heat exchanger 200 to which the method for preventing contamination in heat exchangers according to the embodiment of the present invention is applied, a plurality of heat transfer tubes 220 cross a water tank 210 filled with hot water, and combustion gas generated during fuel combustion passes through the heat transfer tubes 220 during an exhaust process, such that heat of the combustion gas is transferred to the hot water of the water tank 210 through the heat transfer tubes 220 to heat the hot water.

A combustion chamber 230 is formed in an upper portion of the water tank 210 to be opened upward, and upper ends of the heat transfer tubes 220 are connected to the combustion chamber 230. The combustion gas generated in the combustion chamber 230 may be introduced into the upper ends of the heat transfer tubes 220, traverse the water tank 210 from top to bottom while flowing through the heat transfer tubes 220, and then be discharged through lower ends of the heat transfer tubes 220.

A direct water supply portion 211 supplying direct water from the outside into the water tank 210 is provided at a lower portion of the water tank 210, and a hot water discharge portion 212 discharging the hot water heated in the water tank 210 to the outside may be provided at the upper portion of the water tank 210.

In the storage-type heat exchanger 200 configured as described above, the condensate may be generated inside the heat transfer tubes 220 according to a temperature of the hot water inside the water tank 210. Specifically, the condensate may be generated when the temperature of the hot water in the water tank 210 is 55° C. or less. At this time, when the temperature of the hot water is around 55° C., the generation of the condensate and drying may be repeatedly performed.

The storage-type heat exchanger 200 having the above-described form, like the instantaneous heat exchanger 100, may generate the condensate up to a higher section when the amount of heat of the combustion gas is low than when the amount of heat of the combustion gas is high. Specifically, FIG. 2 exemplarily shows that a section in which the condensate is generated is H3 when the amount of heat of the combustion gas is relatively high, and a section in which the condensate is generated is H4 when the amount of heat of the combustion gas is relatively low. Therefore, in a section other than a section overlapping with the H3 section among the H4 section, the generation of the condensate and the drying are repeatedly performed, and a large amount of the corrosion-causing substance may be generated in this section.

Meanwhile, the storage-type heat exchanger 200 of FIG. 2 may be applied to heating the heating water as well as generating the hot water. In this case, the heating return water may be introduced through a direct water supply portion 211 located on a lower side of the water tank 210, and the heated heating water may be discharged through a hot water discharge portion 212 located on an upper side of the water tank 210.

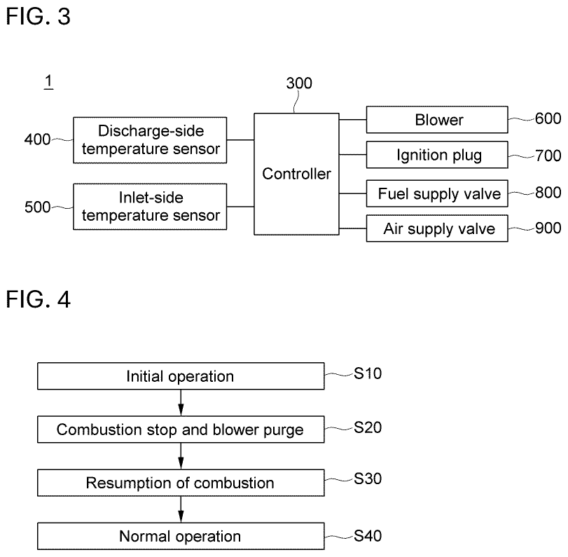

FIG. 3 is a configuration diagram showing a relationship among components used in the method for preventing contamination in heat exchangers according to an embodiment of the present invention.

A combustion device 1 such as a boiler equipped with a heat exchanger may include a controller 300, a discharge-side temperature sensor 400, an inlet-side temperature sensor 500, a blower 600, an ignition plug 700, a fuel supply valve 800, and an air supply valve 900.

The controller 300 may automatically control operations of the blower 600, the ignition plug 700, the fuel supply valve 800, and the air supply valve 900 according to temperature data detected by the discharge-side temperature sensor 400 and the inlet-side temperature sensor 500.

The discharge-side temperature sensor 400 may be provided on a discharge side of the heating water or hot water, and the inlet-side temperature sensor 500 may be provided on an inlet side of the heating return water or direct water. That is, the discharge-side temperature sensor 400 may measure a discharge temperature of the heating water or a discharge temperature of the hot water discharged from the heat exchanger, and the inlet-side temperature sensor 500 may measure a temperature of the heating return water or a temperature of the direct water introduced into the heat exchanger.

The blower 600 generates and sends wind from a supply side of fuel and air toward a burner (not shown) located at an upper portion of the heat exchanger, and may supply a mixed gas in which the fuel and the air are mixed toward the burner or may supply only compressed air toward the burner. Specifically, when both the fuel supply valve 800 and the air supply valve 900 are opened, the mixed gas may be supplied toward the burner, and when only the air supply valve 900 is opened while the fuel supply valve 800 is closed, only the compressed air may be supplied toward the burner. In addition, a flame generated during combustion in the combustion chamber is also directed toward the heat exchanger by the wind generated by the blower 600, and a flow in which the combustion gas is also discharged to the outside after passing through the heat exchanger may be formed.

The ignition plug 700 is provided in the burner to ignite and generate the flame when the mixed gas of the fuel and the air is injected from the burner. The fuel supply valve 800 may control a supply of fuel such as gas and the like, and the air supply valve 900 may control a supply of the air.

According to the combustion device 1 having the above configurations, start of combustion, combustion stop, resumption of combustion, and the like may be controlled by controlling the operations of the blower 600, the ignition plug 700, the fuel supply valve 800, and the air supply valve 900. Furthermore, an amount of heat transferred to the heating water or the hot water through the combustion gas and the heat transfer tubes 121 and 220 may also be controlled.

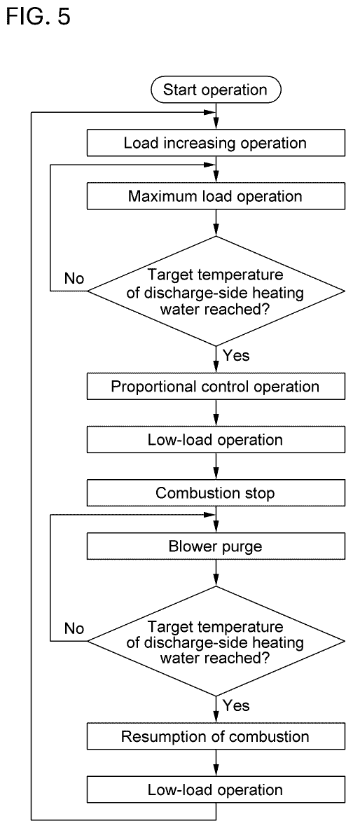

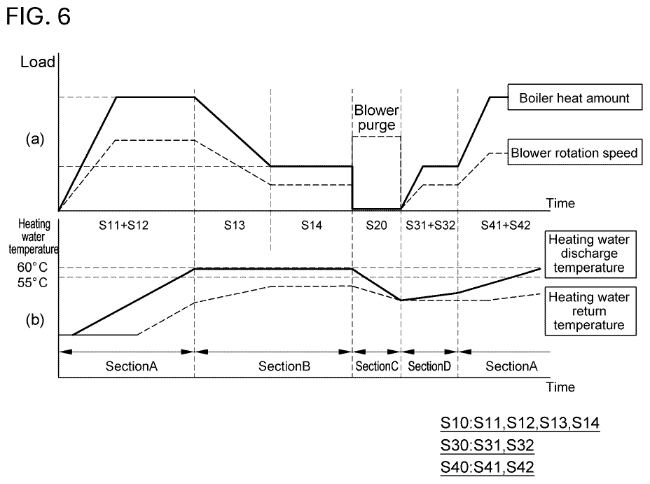

FIG. 4 is a flowchart according to the method for preventing contamination in heat exchangers according to an embodiment of the present invention, FIG. 5 is a flow diagram showing an order in which processes are performed according to the method for preventing contamination in heat exchangers according to an embodiment of the present invention, and FIG. 6 is a graph showing changes in a boiler heat amount, a blower rotation speed, a heating water discharge temperature, and a heating water return temperature in a process in which processes are performed according to the method for preventing contamination in heat exchangers according to an embodiment of the present invention.

The method for preventing contamination in heat exchangers according to an embodiment of the present invention may include an initial operation step S10, a combustion stop and blower purge step S20, a cleaning step S30, and a normal operation step S40.

In the initial operation step S10, the operation of the combustion device is started while the controller 300 controls the operations of the blower 600, the ignition plug 700, the fuel supply valve 800, and the air supply valve 900 according to an operation signal, and is continuously operated for a predetermined time, for example, 1 hour, to generate a sufficient heating effect or hot water effect.

The initial operation step S10 may include a first load increasing section S11, a first maximum load section S12, a first proportional control section S13, and a first low-load section S14.

In the first load increasing section S11, the amount of heat transferred to the heating water or the hot water may be gradually increased by starting the operation of the combustion device and increasing a load until the load reaches a set maximum value. In this process, the rotation speed of the blower 600 may also continuously increase.

In the first maximum load section S12, when the load reaches the set maximum value, the temperature of the heating water may be increased to a target temperature, for example, 60° C., while maintaining a maximum load state, that is, a maximum heat amount. In this process, the rotation speed of the blower 600 may also be maintained at a maximum value preset by a user and the like.

In the first proportional control section S13, the load may be gradually decreased. When the temperature of the heating water rises to the target temperature through the first load increasing section S11 and the first maximum load section S12, the load, that is, the heat amount, may be gradually decreased because the temperature of the heating water can be maintained at the target temperature even when the load is decreased. That is, since a load amount required to maintain the heating water at a maximum target temperature is naturally smaller than a load amount when initially increasing the temperature of the heating water, the load may be gradually decreased through the first proportional control section S13. In the first proportional control section S13, the rotation speed of the blower 600 may gradually decrease.

In the first low-load section S14, a minimum load required for the heating water to maintain the maximum target temperature may be provided. In the first low-load section S14, the rotation speed of the blower 600 may be maintained in a decreased state.

In the combustion stop and blower purge step S20, the operation of the ignition plug 700 is stopped and the fuel supply valve 800 is closed to stop combustion in the burner, and the operation of the blower 600 is continuously maintained to continuously supply the compressed air toward the heat exchanger through the burner. At this time, the rotation speed of the blower 600 may be controlled to be greater than the rotation speed in the first low-load section S14 and less than or equal to a preset maximum rotation speed.

In the combustion stop and blower purge step S20, various contaminants including the corrosion-causing substance and the condensate in the heat exchanger may be removed together using high-pressure air. Furthermore, a temperature of the heating water or the hot water in the heat transfer tube 121 may be lowered using the high-pressure air. The combustion stop and blower purge step S20 may proceed until both the heating water discharge temperature or the hot water discharge temperature drop to or below a condensing temperature.

The cleaning step S30 is a step of increasing the amount of heat transferred to the heating water by increasing the load while resuming combustion in a state in which the discharge temperature of the heating water or the hot water drops to or below the condensing temperature, and may include a second load increasing section S31 and a second low-load section S32.

In the second load increasing section S31, the load is gradually increased, but control may be performed such that both the heating water return temperature and the discharge temperature are located in a section equal to or lower than the condensing temperature. Even in the second low-load section S32, once the load reaches a preset target value through the second load increasing section S31, the load may be maintained at a constant level, while control is performed such that both the heating water return temperature and the discharge temperature are maintained at or below the condensing temperature. In addition, in the cleaning step S30, the rotation speed of the blower 600 also goes through a step of increasing and maintaining corresponding to the increase and maintenance of the load.

In the cleaning step S30, since both the heating water return temperature and the discharge temperature are controlled to be equal to or less than the condensing temperature, the condensate may be generated in an entire section or most sections of the heat transfer tube filled with the heating water.

In the second low-load section S32 of the cleaning step S30, more condensate may be generated compared to the first low-load section S14 of the initial operation step S10.

In this way, in the cleaning step S30, a large amount of the condensate is generated in the heat exchanger, and the generated condensate may be blown by the wind of the blower to wash away foreign substances attached to a surface of a metal component. That is, the foreign substances attached to the surface of the heat transfer tube or the heat transfer fin dissolve in the condensate, and may be discharged together with the condensate by the wind of the blower.

The normal operation step S40 is a process of increasing the temperature of the heating water while gradually increasing the load after passing through the cleaning step S30, and may include a third load increasing section S41, a second maximum load section S42, a second proportional control section not shown, and a third low-load section not shown, which correspond to the first load increasing section S11, the first maximum load section S12, the first proportional control section S13, and the first low-load section S14 of the initial operation step S10.

After the normal operation step S40 is started, a process of normal operation→combustion stop and blower purge→cleaning→normal operation may be repeated. That is, the initial operation is performed only during an initial operation of the combustion device 1, and thereafter, remaining processes except for the initial operation may be repeatedly performed.

After the normal operation step S40 is started, more condensate is generated in the second low-load section S32 of the cleaning step S30 than in the third low-load section of the normal operation step S40, so that the contaminants inside the heat exchanger can be effectively cleaned as described above.

As described above, the method for preventing contamination in heat exchangers according to a preferred embodiment of the present invention has been described in detail with reference to the accompanying drawings, but the present invention is not limited to the above-described embodiment and may be variously modified and implemented within the scope of the claims.

### REFERENCE NUMERALS

1: Combustion device 100: Instantaneous heat exchanger
110: Heat exchanger housing 111: Intake portion
112: Exhaust portion 120: Heat exchange portion
121: Heat transfer tube 122: Heat transfer fin
200: Storage-type heat exchanger 210: Water tank
211: Direct water supply portion 212: Hot water discharge portion
220: Heat transfer tube 230: Combustion chamber
300: Controller 400: Discharge-side temperature sensor
500: Inlet-side temperature sensor 600: Blower
700: Ignition plug 800: Fuel supply valve
900: Air supply valve

1. A method for preventing contamination in heat exchangers, comprising: a blower purge step of removing contaminants inside a heat exchanger through blowing after combustion is stopped; and
a cleaning step of cleaning an inside of the heat exchanger after the blower purge step.

2. The method of claim 1, wherein
the blower purge step comprises:
removing condensate and the contaminants including a corrosion-causing substance inside the heat exchanger through the blowing.

3. The method of claim 1, wherein
the blower purge step comprises:
preventing blockage of a combustion gas passage inside the heat exchanger through the blowing.

4. The method of claim 1, wherein
the blower purge step
proceeds until a discharge temperature of heating water or hot water discharged from the heat exchanger drops to or below a condensing temperature.

5. The method of claim 2, wherein
in the cleaning step, the condensate is generated inside the heat exchanger during a process of resuming the combustion after the blower purge step, and the contaminants including the corrosion-causing substance inside the heat exchanger are cleaned with the generated condensate.

6. The method of claim 5, wherein
in the cleaning step, the discharge temperature of the heating water or the hot water discharged from the heat exchanger is controlled to be maintained at or below the condensing temperature.

7. The method of claim 1, further comprising:
an initial operation step of starting operation of the combustion device according to an operation signal to continuously perform combustion for a set time prior to a combustion stop step.

8. The method of claim 7, wherein
the initial operation step comprises:
a first load increasing section for increasing a load according to the operation signal;
a first maximum load section for maintaining a maximum load after the first load increasing section;
a first proportional control section for gradually decreasing the load after the first maximum load section; and
a first low-load section for maintaining the load in a low-load state after the first proportional control section.

9. The method of claim 8, wherein
the cleaning step comprises:
a second load increasing section for increasing an amount of heat transferred to the heat exchanger; and
a second low-load section for keeping the load constant after the second load increasing section.

10. The method of claim 9, further comprising:
a normal operation step of passing through a second maximum load section for maintaining a maximum load after passing through a third load increasing section for increasing the load after the cleaning step.

11. The method of claim 10, wherein
the normal operation step further comprises:
a second proportional control section for gradually decreasing the load after the second maximum load section; and
a third low-load section for maintaining the load in a low-load state after the second proportional control section.

12. The method of claim 10, wherein
more condensate is generated in the second low-load section than in the first low-load section and the third low-load section.

13. The method of claim 10, wherein
in the blower purge step, a rotation speed of a blower is controlled to be greater than a rotation speed in the first low-load section and the third low-load section and less than or equal to a set maximum rotation speed.

14. The method of claim 10, wherein
after the initial operation step, a combustion stop, the blower purge step, the cleaning step, and the normal operation step are repeated.

15. A method for preventing contamination in heat exchangers, comprising: a normal operation step of a combustion device;
a blower purge step of removing contaminants inside a heat exchanger through blowing after combustion is stopped; and
a cleaning step of cleaning an inside of the heat exchanger after the blower purge step.

16. The method of claim 15, wherein
the cleaning step comprises generating condensate inside the heat exchanger while resuming combustion, and cleaning the contaminants including a corrosion-causing substance inside the heat exchanger with the generated condensate.

17. The method of claim 15, wherein
the blower purge step comprises removing the condensate and the contaminants including the corrosion-causing substance inside the heat exchanger through the blowing.

18. The method of claim 15, wherein
the blower purge step comprises preventing blockage of a combustion gas passage inside the heat exchanger through the blowing.

19. The method of claim 15, wherein
the blower purge step proceeds until a discharge temperature of heating water or hot water discharged from the heat exchanger drops to or below a condensing temperature.

20. A method for preventing contamination in heat exchangers, comprising: a blower purge step of removing contaminants and condensate inside a heat exchanger by performing blowing after stopping combustion;
a condensation generating step of generating the condensate inside the heat exchanger by controlling a discharge temperature of heating water or hot water discharged from the heat exchanger to be maintained at or below a condensing temperature while resuming combustion; and
a cleaning step of cleaning an inside of the heat exchanger by the generated condensate, wherein
the combustion stop, the blower purge step, the condensation generating step, and the cleaning step are repeatedly performed.
